(19) United States
(12) Patent Application Publication
(10) Pub. No.: US 2024/0292816 A1
(43) Pub. Date: Sep. 5, 2024

(54) FISH STRINGER APPARATUS

(71) Applicant: Jett Million, Kodiak, AK (US)

(72) Inventor: Jett Million, Kodiak, AK (US)

(21) Appl. No.: 18/116,815

(22) Filed: Mar. 2, 2023

(51) Int. Cl. A01K 97/00

(52) U.S. Cl. CPC A01K 65/00

(57) ABSTRACT

A fish stringer apparatus for stringing fish together to anchor the fish while retaining the fish in water and to carry the fish includes a clasp and a pair of threading members. Each threading member of the pair of threading members extend away from the clasp. Each threading member includes a flexible cord with a rigid pin mounted on the end of the flexible cord. Each threading member is threadable through a gill and a mouth of a fish to string the fish onto the threading member. Each threading member is also drivable into a ground surface to anchor the fish stringer apparatus. The clasp is engageable with either threading member to create a closed loop for maintaining the fish on the threading member.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fish stringer devices and more particularly pertains to a new fish stringer device for stringing fish together to anchor the fish while retaining the fish in water and to carry the fish.

### (2) Description of Related Art Including Information Disclosed Under 37 CFR 1.97 and 1.98

The prior art provides myriad examples of fish stringer devices which attach fish onto the device for carrying the fish and for maintaining them in a secured location in the water to keep them alive. These devices are typically structured to string the fish onto separate clips which are all attached to another structural element or to string the fish onto a cord separated by some sort of spacer. Most pertinently, U.S. Pat. No. 5,031,809 discloses a fish stringer device which includes a clasp that is arranged to form a closed loop with a line on which the fish are strung. The clasp hooks onto a loop in the line. A second cord is attached to the clasp and includes a rigid member for anchoring the device to a ground surface. The cords in this device have different structures given their different purposes.

The prior art does not disclose a fish stringer device with a clasp and at least a pair of cords, each of which can be used to form a loop with the clasp to store strung fish and each of which can be driven into a ground surface to anchor the device. Such an arrangement provides redundancy that is advantageous in the case of damage to one of the cords, and also allows for additional capacity for fish if an alternative anchoring means is used. The prior art also fails to provide for the use of kernmantle rope for the cords, which is less likely to cause lacerations, abrasions, or pain to a user from handling cords of alternative materials such as fishing line.

### BRIEF SUMMARY OF THE INVENTION

An embodiment of the disclosure meets the needs presented above by generally comprising a clasp with a body and a gate. The clasp has an aperture which is bounded by the body and the gate, and the gate is movable with respect to the body to open and close the aperture on a peripheral edge of the aperture. Each threading member of a pair of threading members is coupled to and extends away from the clasp. Each threading member of the pair of threading members comprises a cord and a pin. The cord is coupled to and extends away from the clasp. The pin is rigid and is coupled to a free end of the cord. The pin is configured for threading through a mouth and a gill of a fish. The pin is also configured for being driven into a ground surface. The clasp is engageable with a selected threading member of the pair of threading members such that the selected threading member forms a closed loop with the clasp. The pin of the selected threading member is shaped to be retainable against the clasp when the clasp engages the selected threading member to form the closed loop.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a fish stringer apparatus according to an embodiment of the disclosure.

FIG. 2 is a side view of an embodiment of the disclosure.

FIG. 3 is an in-use view of an embodiment of the disclosure.

### DETAILED DESCRIPTION OF THE INVENTION

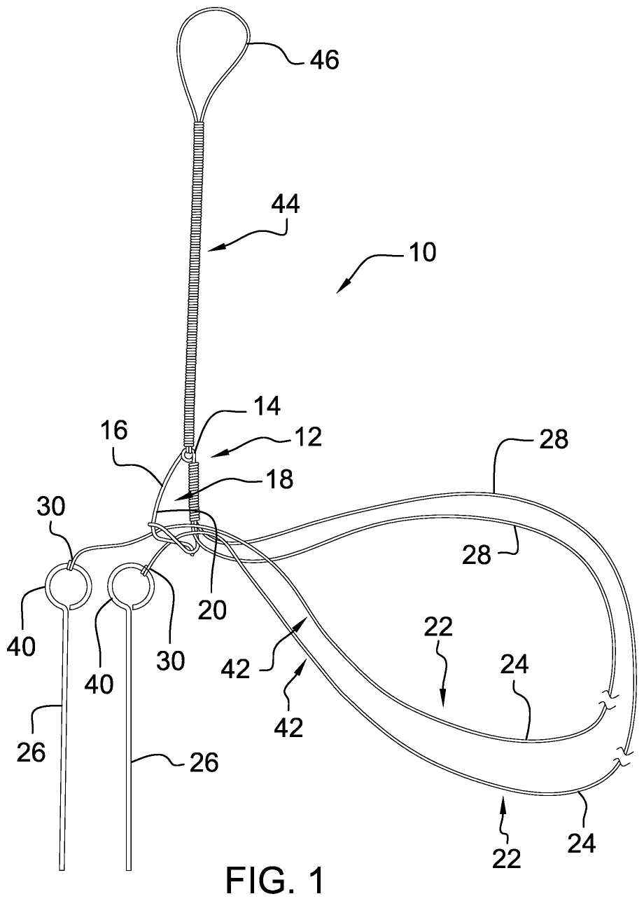

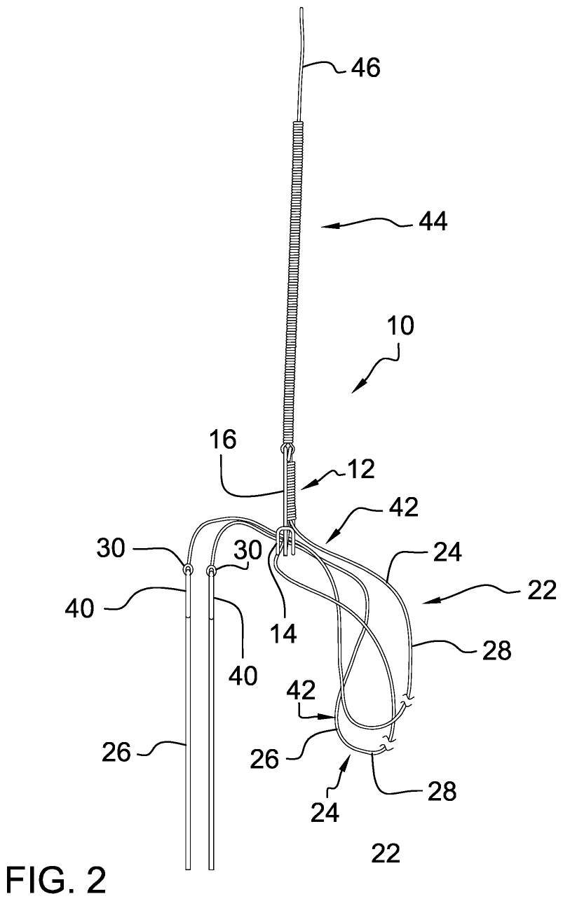

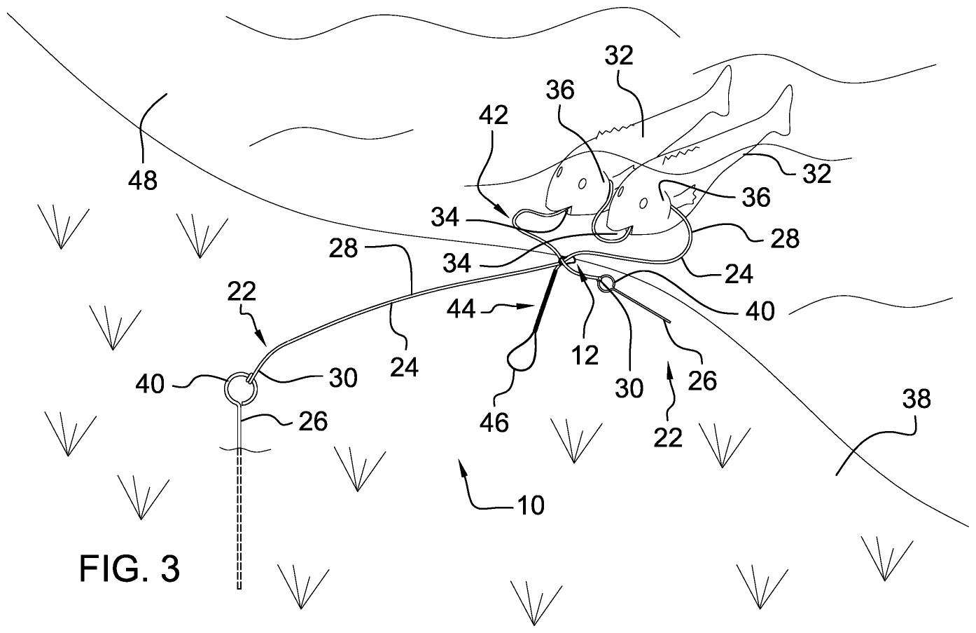

With reference now to the drawings, and in particular to FIGS. 1 through 3 thereof, a new fish stringer device embodying the principles and concepts of an embodiment of the disclosure and generally designated by the reference numeral 10 will be described.

As best illustrated in FIGS. 1 through 3, the fish stringer apparatus 10 generally comprises a clasp 12 with a body 14 and a gate 16. The clasp 12 has an aperture 18 which is bounded by the body 14 and the gate 16, and the gate 16 is movable with respect to the body 14 to open and close the aperture 18 on a peripheral edge 20 of the aperture 18. The gate 16 is biased to close the clasp 12 and is pivotable with respect to the body 14 inwardly with respect to the aperture 18 to open the aperture 18.

Each threading member 22 of a pair of threading members 22 is coupled to and extends away from the clasp 12. Each threading member 22 of the pair of threading members 22 comprises a cord 24 and a pin 26. The cord 24 is coupled to and extends away from the clasp 12. The cord 24 is tied to the body 14 of the clasp 12. The cord 24 also comprises a kernmantle rope 28. Kernmantle rope 28 is rope which is constructed with a core which withstands loads placed on the rope and a sheath surrounding the core which protects the core from abrasion. The sheath can also act as a buffer between the core and a user's hands to protect the user's hands from lacerations, abrasions, or other injuries that could be caused by the core. The kernmantle rope 28 used in the present invention may be 550 paracord, which is constructed of nylon and is specified to have a minimum tensile strength of 550 pounds. The pin 26 is rigid and is coupled to a free end 30 of the cord 24. The pin 26 is configured for threading through a mouth 34 and a gill 36 of a fish 32. The pin 26 is also configured for being driven into a ground surface 38. The pin 26 has a closed loop end 40 which is coupled to the free end 30 of the cord 24.

The clasp 12 is engageable with a selected threading member 22 of the pair of threading members 22 such that the selected threading member 22 forms a closed loop 42 with the clasp 12. The pin 26 of the selected threading member 22 is shaped to be retainable against the clasp 12 when the clasp 12 engages the selected threading member 22 to form the closed loop 42. The closed loop end 40 of the pin 26 of the selected threading member 22 has a size such that the pin 26 of the selected threading member 22 is retainable against the clasp 12 when the clasp 12 engages the selected threading member 22 to form the closed loop 42.

A handle 44 is also coupled to and extends away from the clasp 12. The handle 44 has a closed loop end 40 distal from the clasp 12 for hanging the fish stringer apparatus 10. The handle 44 also comprises the kernmantle rope 28 and may be tied in a coil between the clasp 12 and the closed loop end 46 of the handle 44 to achieve a greater width than the handle 44 would otherwise have for improved grip.

In use, the selected threading member 22 is threaded through the mouth 34 and the gill 36 of the fish 32 to keep the fish 32 secured to the fish stringer apparatus 10. The clasp 12 is placed in engagement with the selected threading member 22 to form the closed loop 42 such that the fish 32 does not become removed from the selected threading member 22. The fish 32 is placed in water 48 to keep the fish 32 alive while being strung on the fish stringer apparatus 10, and the pin 26 of the other threading member 22 of the pair of threading members 22 is driven into the ground surface 38 to anchor the fish stringer apparatus 10. The pair of threading members 22 are interchangeably usable for either stringing the fish 32 or anchoring the fish stringer apparatus 10. Multiple fish 32 may be strung on the selected threading member 22. Both threading members 22 may be used to string fish 32 if an alternative anchoring means is used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fish stringer apparatus comprising:
a clasp having a body and a gate, the clasp having an aperture being bounded by the body and the gate, the gate being movable with respect to the body to open and close the aperture on a peripheral edge thereof;
a pair of threading members, each threading member of the pair of threading members being coupled to and extending away from the clasp, each threading member of the pair of threading members comprising:
a cord being coupled to and extending away from the clasp; and
a pin being coupled to a free end of the cord, the pin being rigid, the pin being configured for threading through a mouth and a gill of a fish, the pin being configured for being driven into a ground surface; and
the clasp being engageable with a selected threading member of the pair of threading members such that the selected threading member forms a closed loop with the clasp, the pin of the selected threading member being shaped to be retainable against the clasp when the clasp engages the selected threading member to form the closed loop.

2. The apparatus of claim 1, wherein the gate is biased to close the clasp.

3. The apparatus of claim 1, wherein the gate is pivotable with respect to the body inwardly with respect to the aperture to open the aperture.

4. The apparatus of claim 1, wherein the cord is tied to the body of the clasp.

5. The apparatus of claim 1, wherein the cord comprises a kernmantle rope.

6. The apparatus of claim 1, wherein the pin has a closed loop end of the pin being coupled to the free end of the cord the closed loop end of the pin of the selected threading member having a size such that the pin of the selected threading member is retainable against the clasp when the clasp engages the selected threading member to form the closed loop.

7. The apparatus of claim 1, further comprising a handle being coupled to and extending away from the clasp.

8. The apparatus of claim 7, wherein the handle has a closed loop end distal from the clasp.

9. The apparatus of claim 7, wherein the handle comprises a kernmantle rope.

10. A fish stringer apparatus comprising:
a clasp having a body and a gate, the clasp having an aperture being bounded by the body and the gate, the gate being movable with respect to the body to open and close the aperture on a peripheral edge thereof, the gate being biased to close the clasp, the gate being pivotable with respect to the body inwardly with respect to the aperture to open the aperture;
a pair of threading members, each threading member of the pair of threading members being coupled to and extending away from the clasp, each threading member of the pair of threading members comprising:
a cord being coupled to and extending away from the clasp, the cord being tied to the body of the clasp, the cord comprising a kernmantle rope; and
a pin being coupled to a free end of the cord, the pin being rigid, the pin being configured for threading through a mouth and a gill of a fish, the pin being configured for being driven into a ground surface, the pin having a closed loop end of the pin being coupled to the free end of the cord;
the clasp being engageable with a selected threading member of the pair of threading members such that the selected threading member forms a closed loop with the clasp, the pin of the selected threading member being shaped to be retainable against the clasp when the clasp engages the selected threading member to form the closed loop, the closed loop end of the pin of the selected threading member having a size such that the pin of the selected threading member is retainable against the clasp when the clasp engages the selected threading member to form the closed loop; and
a handle being coupled to and extending away from the clasp, the handle having a closed loop end distal from the clasp, the handle comprising the kernmantle rope.
